(19) United States
(12) Patent Application Publication
(10) Pub. No.: US 2005/0145809 A1
(43) Pub. Date: Jul. 7, 2005

(54) Multifunctional valve device

(76) Inventor: Wen-Tsong Lee, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/751,818

(22) Filed: Jan. 5, 2004

(51) Int. Cl. F16K 31/44

(52) U.S. Cl. 251/83

(57) ABSTRACT

A multifunctional valve device includes a valve body and a plug mounted in the valve body. A partitioning wall separates an interior of the valve body into two chambers respectively communicated with an inlet and an outlet. The partitioning wall includes a hole communicating the first chamber with the second chamber. A seat is coupled in a coupling hole of the valve body and includes a screw hole for threadedly engaging with the operative rod. The operative rod includes a first end abutting against the plug and a second end outside the valve body for manual operation. A spring biases the plug to seal the hole of the valve body. The multifunctional valve may act as a stop valve, a limiting valve, and a check valve, depending on the position of the operative rod relative to the plug seat.

### BACKGROUND OF THE INVENTION

1. Field of the Invention

The present invention relates to a multifunctional valve device that may act as a stop valve, a limiting valve, and a check valve.

2. Description of the Related Art

FIG. 1 of the drawings illustrates a conventional pressure piping system for supplying low-pressure fluid from a low-pressure pipe 11 to a sealed pressurized fluid reservoir 12 or a non-sealing type reservoir at a higher location. To assure smooth flow of the fluid and prevents the fluid from entering the low-pressure pipe 11 while preventing the pressure of the system from exceeding a predetermined range for safety purposes, the pressure piping system includes a stop valve 13, a first connecting tube 14, a check valve 15, a second connecting tube 16, a coupler 17, a relief valve 18, and sealing tapes 19.

The elements of the pressure piping system are independent from one another in structure, wherein the stop valve 13 provides the functions of allowing/stopping passage of the fluid. The check valve 15 includes a valve body 151, a plug seat 152 mounted in the valve body 151, and a plug 153 that moves up and down relative to the plug seat 152 in response to a change of the pressure of the incoming fluid. The fluid flows when the plug 153 is disengaged from the plug seat 152, and the fluid cannot flow when the plug 153 is engaged with the plug seat 152. The fluid pressure in the reservoir 12 does not drop, as the fluid in the reservoir 12 cannot flow in the reverse direction. However, the plug 153 can only move in the vertical direction.

Threading is requisite to the first and second connecting tubes 14 and 16 as well as the coupler 17. As illustrated in FIG. 1, the elements of the pressure piping system are serially connected to an inlet pipe 121 of the reservoir 12. The functions of the check valve 15 and the relief valve 18 become effective when the fluid fills the reservoir 12 and is pressurized. Since the threading in the pressure piping system is formed by means of mechanically processing hard materials, the threading coupling between the respective connecting tube and the associated coupler or pipe could not provide required sealing/anti-leaking effect. Thus, the sealing tape 19 is wound around the respective male threading portion of the pressure piping system to a certain extent before the respective male threading portion is engaged in the respective female threading portion, providing a certain anti-leaking effect.

However, the elements of the pressure piping system are often not manufactured by the same factory such that the sizes of the threading of the connecting tubes and the couplers cannot be easily controlled. Hence, there is no guarantee that the respective sealing tape 19 assures the anti-leaking effect for the respective tube or coupler. A typical pressure piping system includes many threading coupling points, and leaking in any one of the threading coupling points results in malfunctioning of the whole pressure piping system. The fluid in the reservoir 12 must be released before replacement of the old sealing tape with a new one. After connection of the tubes is completed, pressurizing tests are carried out to assure non-leakage. The repair is labor-intensive and time-consuming, which is particularly true to a steam boiler operating at relatively high temperature and pressure.

### SUMMARY OF THE INVENTION

An object of the present invention is to provide a multifunctional valve device that may act as a stop valve, a limiting valve, and a check valve.

Another object of the present invention is to provide a multifunctional valve device allowing operation of a plug in any orientation.

A further object of the present invention is to provide a multifunctional valve device allowing flow of fluid in both directions.

In accordance with an aspect of the invention, a multifunctional valve device comprises a valve body, a seat, a plug mounted in the valve body, and a spring. The valve body includes an inlet, an outlet, a coupling hole, and a partitioning wall separating an interior of the valve body into a first chamber communicated with the inlet and a second chamber communicated with the outlet. The partitioning wall includes a hole communicating the first chamber with the second chamber. The seat is coupled in the coupling hole of the valve body and includes a screw hole. The operative rod is threadedly engaged in the screw hole of the seat. The operative rod includes a first end abutting against the plug and a second end outside the valve body for manual operation. The spring is mounted between the operative rod and the plug for biasing the plug toward the hole of the valve body, thereby sealing the hole of the valve body.

When the operative rod is turned to a first predetermined position, the plug is moved to a position sealing the hole of the valve body, preventing flow of fluid in the valve body. When the operative rod is turned to move the plug away from the hole of the valve body and when there is a fluid flow in the valve body, the fluid flow overcomes the spring force and allows fluid flow. When the operative rod is turned to move the plug away from the hole of the valve body, the plug is moved to seal the hole of the valve body under at least one of the spring force and a pressure difference between a pressure in the first chamber and a pressure in the second chamber.

Other objects, advantages, and novel features of the invention will become more apparent from the following detailed description when taken in conjunction with the accompanying drawings.

### BRIEF DESCRIPTION OF THE DRAWINGS

FIG. 1 is a schematic sectional view of a conventional pressure piping system.

FIG. 2 is a schematic sectional view of a reservoir and a multifunctional valve device in accordance with the present invention.

FIG. 3 is an exploded perspective view of the multifunctional valve device in accordance with the present invention.

FIG. 4 is a sectional view of the multifunctional valve device in accordance with the present invention device.

FIG. 4A is a sectional view similar to FIG. 4, illustrating a flow-limiting function of the multifunctional valve device.

FIG. 4B is a sectional view similar to FIG. 4, illustrating a check valve function of the multifunctional valve device.

FIG. 5 is an exploded perspective view of a second embodiment of the multifunctional valve device in accordance with the present invention.

FIG. 6 is a sectional view of the multifunctional valve device in FIG. 5.

FIG. 6A is a sectional view similar to FIG. 6, illustrating a flow-limiting function of the multifunctional valve device.

FIG. 6B is a sectional view similar to FIG. 6, illustrating a check valve function of the multifunctional valve device.

FIG. 6C is a sectional view similar to FIG. 6, wherein the multifunctional valve device allows fluid flow in both directions.

FIG. 7 is a sectional view illustrating a modified embodiment of the multifunctional valve device in accordance with the present invention.

FIG. 7A is a sectional view similar to FIG. 7, illustrating a flow-limiting function of the multifunctional valve device.

FIG. 7B is a sectional view similar to FIG. 7, illustrating a check value function of the multifunctional valve device.

FIG. 8 is a sectional view illustrating another modified embodiment of the multifunctional valve device in accordance with the present invention.

FIG. 8A is sectional view similar to FIG. 8, illustrating a check valve function of the multifunctional valve device.

FIG. 8B is a sectional view similar to FIG. 8, wherein the multifunctional valve device allows fluid flow in both directions.

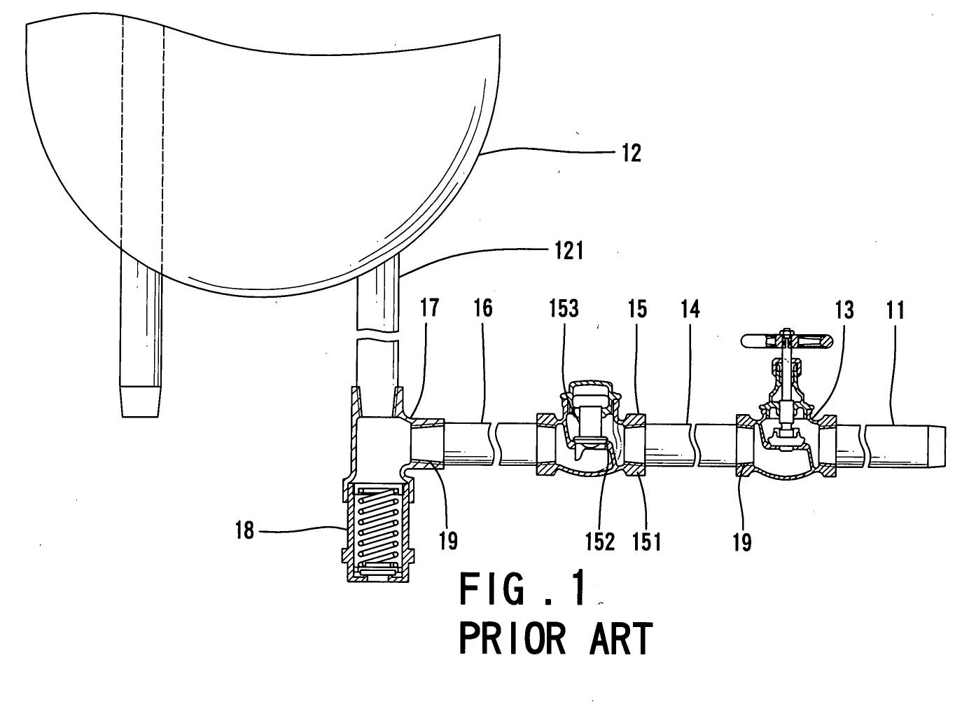

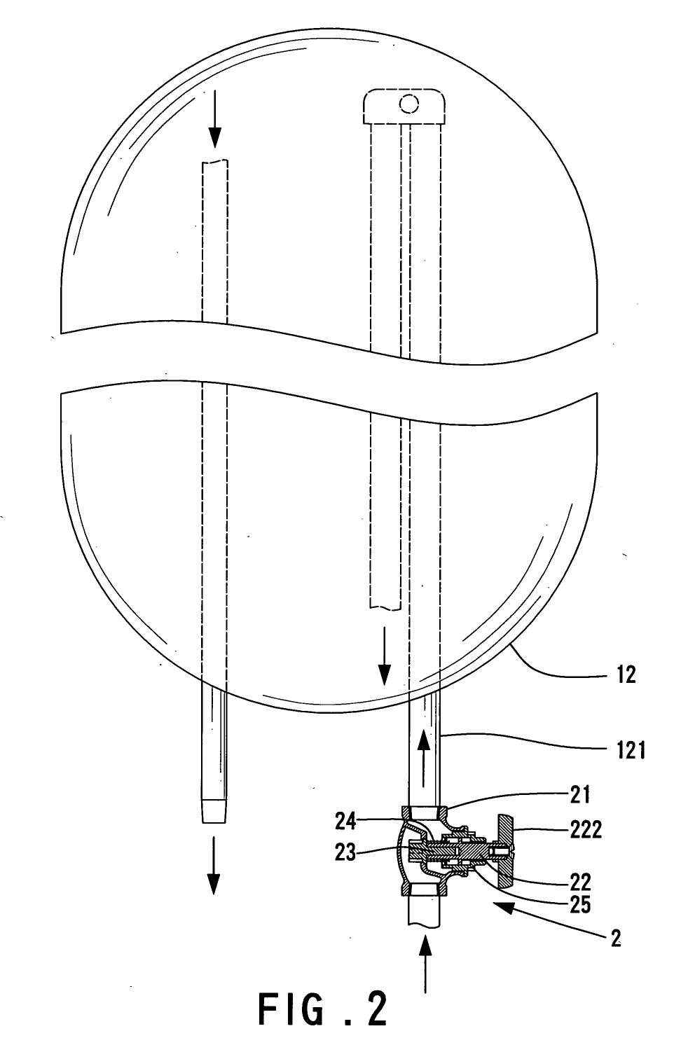

### DETAILED DESCRIPTION OF THE PREFERRED EMBODIMENTS

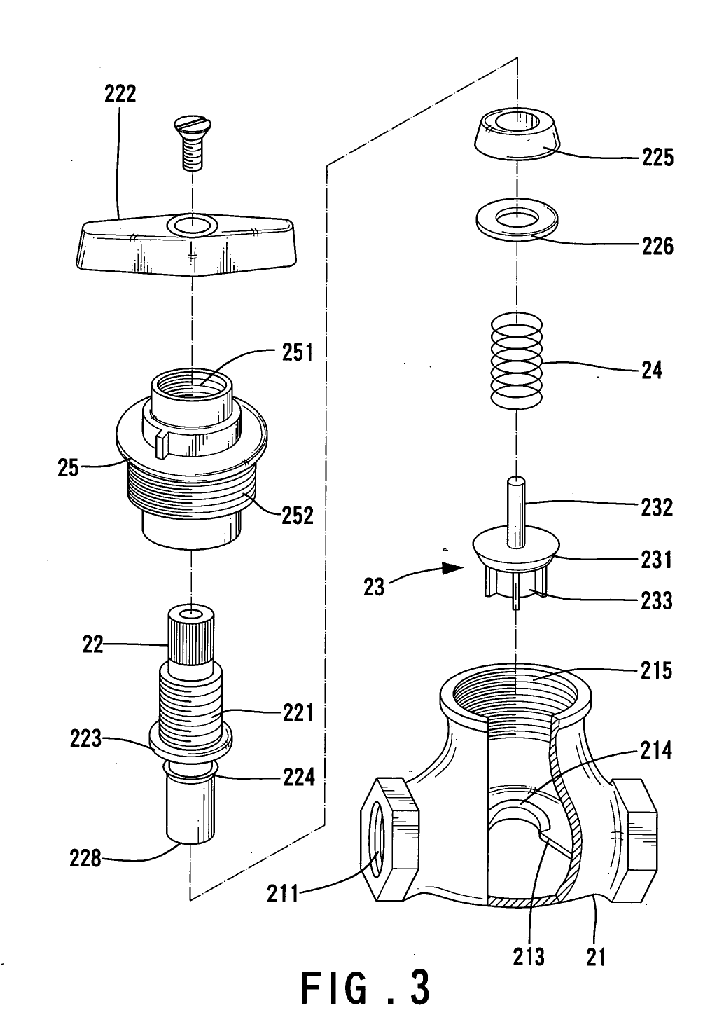

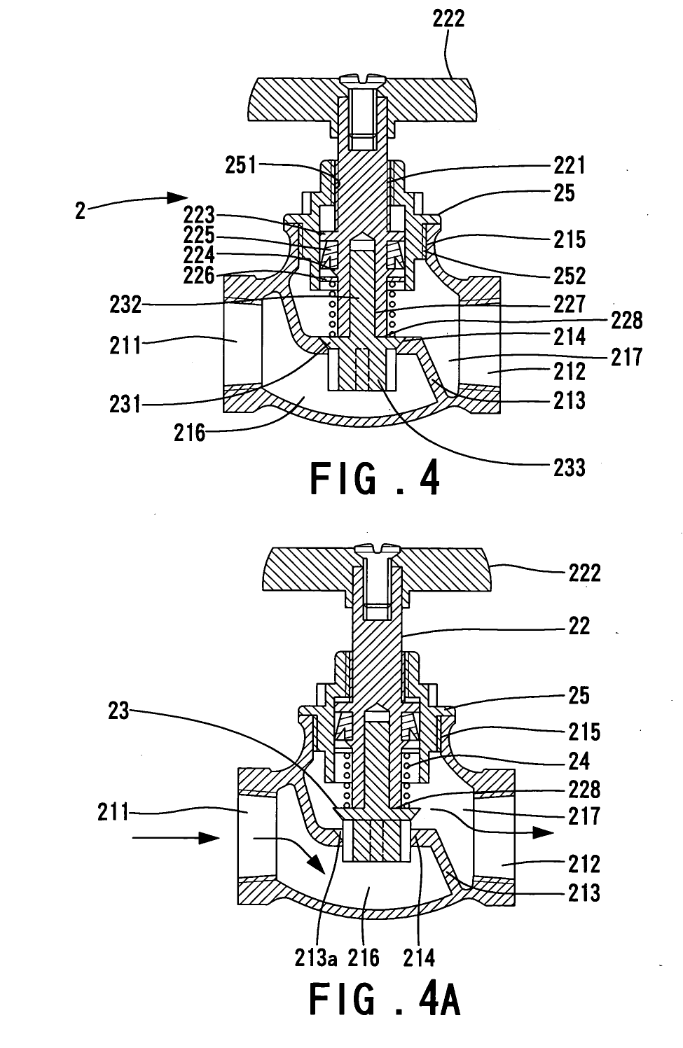

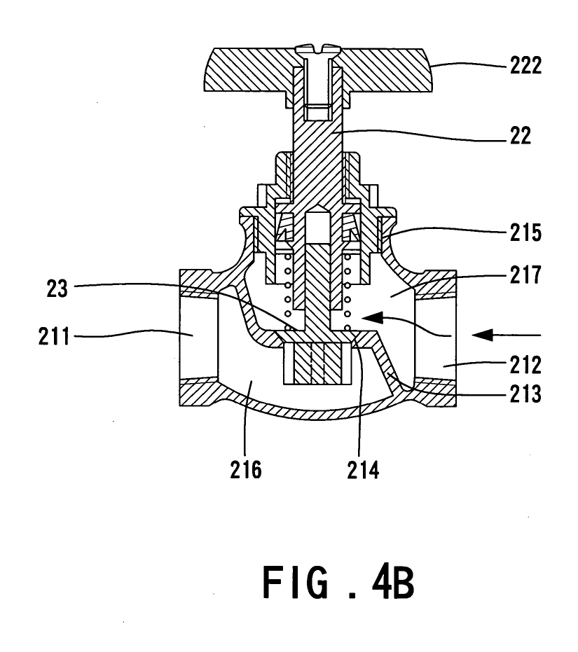

Referring to FIGS. 3 and 4, a multifunctional valve device 2 in accordance with the present invention generally comprises a valve body 21, an operative rod 22, a plug 23, and a spring 24. The valve body 21 includes an inlet 211, an outlet 212, a partitioning wall 213 separating an interior of the valve body 21 into a first chamber 216 communicated with the inlet 211 and a second chamber 217 communicated with the outlet 212, a plug seat 214 formed on the partitioning wall 213 and defined by a peripheral wall delimiting a hole 213a (FIG. 4A) in the partitioning wall 213, and a coupling hole 215. The hole 213a of the partitioning wall 213 communicates the first chamber 216 with the second chamber 217. A seat 25 includes a screw hole 251 and a coupling section 252 coupled with the coupling hole 215.

The operative rod 22 includes a threaded section 221 threadedly engaged with the screw hole 251 of the seat 25, with an end of the operative rod 22 being located in the valve body 21. An operative handle 222 is securely mounted to the other end of the operative rod 22 outside the valve body 21. The operative rod 22 further includes a relatively larger flange 223 and a relatively smaller flange 224 between the threaded section 221 and the end of the operative rod 22, with a sealing washer 225 being sandwiched between the relatively larger flange 223 and the relatively smaller flange 224, and with a washer 226 abutting against a side of the relatively smaller flange 224. Further, a receptacle 227 is defined in an end face 228 of the end of the operative rod 22 and extends along a longitudinal direction of the operative rod 22.

The plug 23 includes a plug body 231 for intimate contact with the plug seat 214. In particular, the plug body 231 includes a smooth peripheral face, with a stem 232 extending from a side of the plug body 231, and with a guiding part 233 being formed on the other side of the plug body 231. The stem 232 is received in the receptacle 227 and slidable along the longitudinal direction of the operative rod 22, with the end face 228 of the operative rod 22 being in contact with the side of the plug body 231.

The spring 24 is mounted around the operative rod 22, with an end of the spring 28 abutting against the washer 226, and with the other end of the spring 28 abutting against the plug body 231, biasing the plug 23 toward the plug seat 214. The elasticity of the spring 24 is so selected that the plug 213 is biased to be in sealing contact with the plug seat 214 and thus seal the hole 213a of the valve body 21 even if the plug 23 is placed upside-down. Nevertheless, normal flow of fluid through the valve body 21 will be adversely affected if the elasticity of the spring 24 is too large. On the other hand, the hole 213a of the valve body 21 cannot be sealed if the elasticity of the spring 24 is too small. It is noted that sealing tapes can be provided to the male threading of the coupling hole 215 of the valve body 21 or of the seat 25.

The multifunctional valve device 2 acts as a stop valve when the operative rod 22 is turned in a direction to move the plug 23 to a position (FIG. 4) completely sealing the hole 213a of the valve body 21. The first chamber 216 is not communicated with the second chamber 217, as the hole 213a of the valve body 21 is sealed by the plug 23. Thus, fluid from the inlet 211 cannot flow to the outlet 212. Flowing of the fluid in the multifunctional valve device 2 is stopped. Thus, the multifunctional valve device 2 acts as a stop valve.

When handle 222 is turned in a reverse direction, the operative rod 22 and the plug 23 are moved away from the plug seat 214, as shown in FIG. 4A. The fluid from the inlet 211 overcomes the spring force of the spring 24 and urges the plug 23 to disengage from the hole 213a of the valve body 21. Thus, the fluid flows to the outlet 212 via the first chamber 216, the hole 213a of the valve body 21, and the second chamber 217. The flux depends on the distance between the plug 23 and the hole 213a of the valve body 21; namely, the flux depends on rotation of the handle 222. The greater the distance between the plug 23 and the hole 213a of the valve body 21, the greater the flux. Thus, the multifunctional valve device 2 acts as a limiting valve.

Referring to FIG. 4B, when the flow from the inlet 211 toward the outlet 212 stops, no force exerts on the plug 23. The plug 23 is biased to a position sealing the hole 213a of the valve body 21 under the action of the spring 24. In a case that the fluid pressure in the second chamber 217 is greater than that in the first chamber 216 due to heating or other causes, the plug 23 is more tightly engaged with the plug seat 214 in which the hole 213 is defined. This prevents undesired flow in the reverse direction. When the fluid pressure in the second chamber 217 is smaller than that in the first chamber 216, the flow resumes, as the fluid is able to overcome the spring force of the spring 24 and to push the plug 23 away from the hole 213a of the valve body 21, providing normal fluid-delivering function. Thus, the multifunctional valve device 2 acts as a check valve.

As mentioned above, the multifunctional valve device 2 acts as a stop valve when the operative rod 22 is turned to move the plug 23 to a position completely sealing the hole 213a of the valve body 21. The multifunctional valve device 2 allows full flow of the fluid when the operative rod 22 is turned to move the plug 23 to a position farthest to the hole 213a of the valve body 21. The multifunctional valve device 2 acts as a limiting valve when the operative rod 22 is turned to move the plug 23 to a position other than the farthest position. The multifunctional valve 2 acts as a check valve when the operative rod 22 is turned to move the plug 23 to a position not sealing the hole 213 of the valve body 21. This multifunctional valve device 2 can be mounted in any orientation. The number of elements of a piping system using the multifunctional valve 2 can be greatly reduced. Namely, the number of tubes, couplers, and sealing tapes can be reduced while effectively reducing the risk of leakage and cutting the cost.

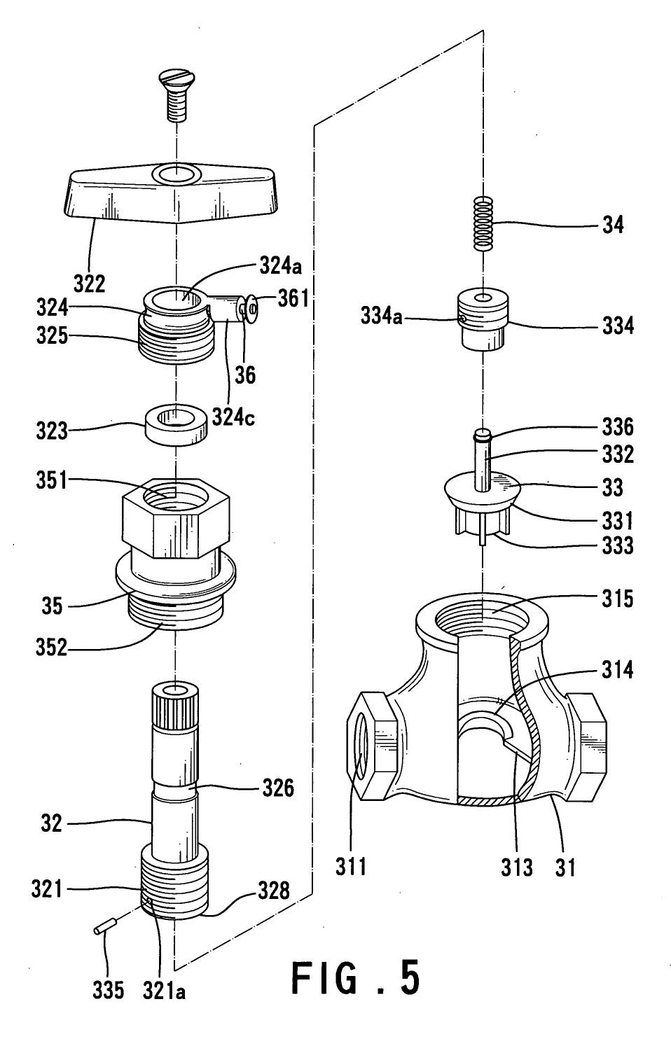

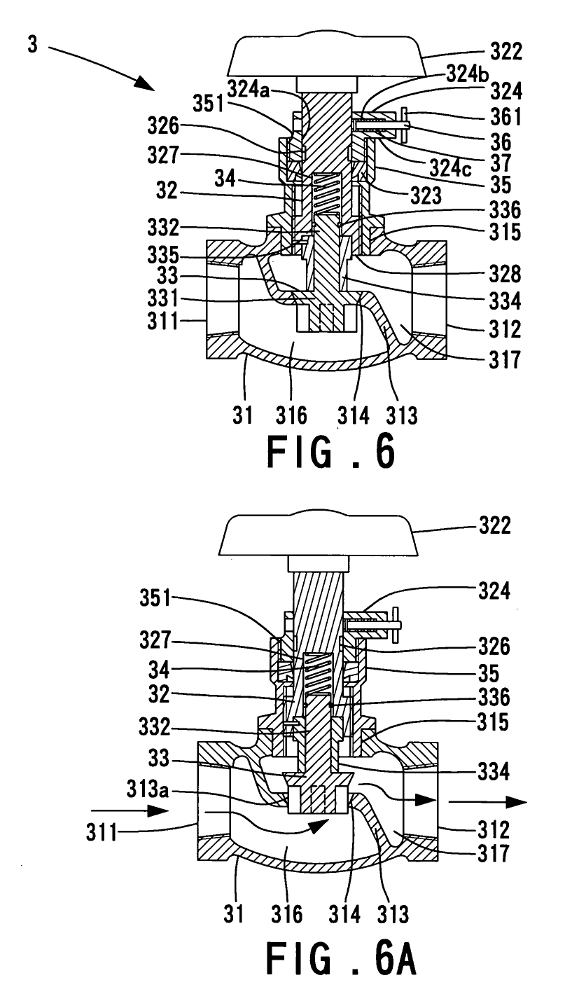

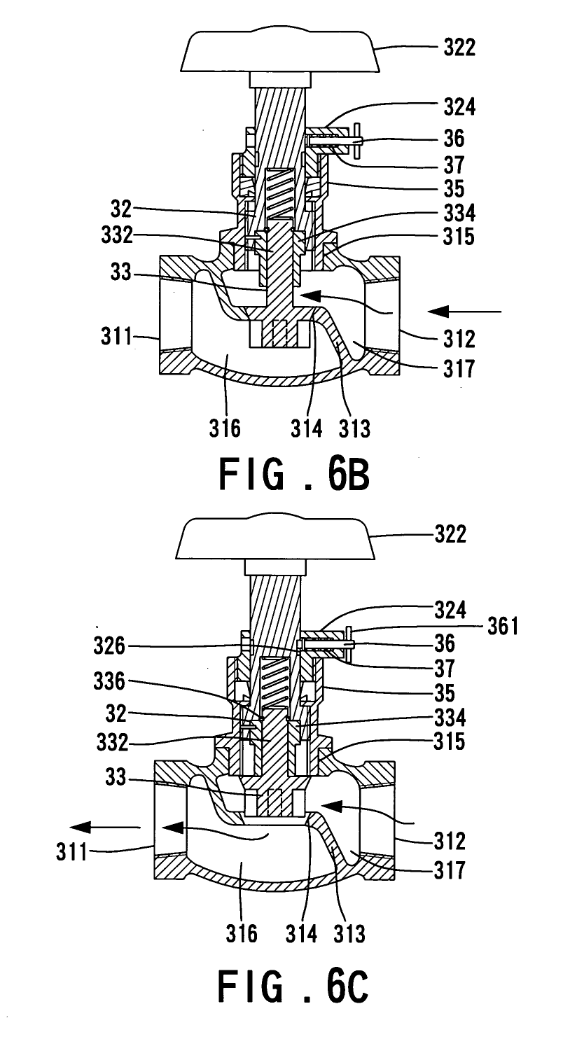

FIGS. 5 and 6 illustrate a second embodiment of the invention, wherein the multifunctional valve device 3 comprises a valve body 31, an operative rod 32, a plug 33, and a spring 34. The valve body 31 includes an inlet 311, an outlet 312, a partitioning wall 313 separating an interior of the valve body 31 into a first chamber 316 communicated with the inlet 311 and a second chamber 317 communicated with the outlet 312, a plug seat 314 formed on the partitioning wall 313 and defined by a peripheral wall delimiting a hole 313a (FIG. 6A) in the partitioning wall 313, and a coupling hole 315. The hole 313a of the partitioning wall 313 communicates the first chamber 316 with the second chamber 317. A seat 35 includes a screw hole 351 and a coupling section 352 coupled with the coupling hole 315.

The operative rod 32 includes a threaded section 321 threadedly engaged with the screw hole 351 of the seat 35, with an end of the operative rod 32 being located in the valve body 31. An operative handle 322 is securely mounted to the other end of the operative rod 32 outside the valve body 31. Further, a receptacle 327 is defined in an end face 328 of the end of the operative rod 32 and extends along a longitudinal direction of the operative rod 32. A sealing washer 323 is mounted around an intermediate portion of the operative rod 32. Mounted around the operative rod 32 and located above the sealing washer 323 is a sealing member 324 having an outer threading 325 on a lower end thereof for threadedly engaging with the screw hole 351 of the seat 35. The sealing member 324 includes a longitudinal hole 324a through which the operative rod 32 extends. An extension 324c extends from a side of the sealing member 324 and includes a transverse hole 324b communicates with the longitudinal hole 324a of the sealing member 324. A locking bar 36 is received in the transverse hole 324b, with a spring 37 being mounted in the transverse hole 324b for biasing an end of the locking bar 36 toward the operative rod 22. An end piece 361 is attached to the other end of the locking bar 35 extending beyond the extension 324c for manual operation. The operative rod 32 further includes a positioning groove 326 in an outer periphery thereof. When the operative rod 32 is moved to a predetermined position, the end of the locking bar 35 is biased by the spring 37 into the positioning groove 326, thereby retaining the operative rod 22 in place.

The plug 33 includes a plug body 331 for intimate contact with the plug seat 314. In particular, the plug body 331 includes a smooth peripheral face, with a stem 332 extending from a side of the plug body 331, and with a guiding part 333 being formed on the other side of the plug body 331. The stem 332 is received in the receptacle 327 of the operative rod 32 and slidable along the longitudinal direction of the operative rod 32, with the end face 328 of the operative rod 32 being in contact with the side of the plug body 331. Further, a positioning collar 334 is mounted around the stem 332, with a positioning pin 335 extending through a radial hole 321a in the threaded section 321 of the operative rod 32 into a radial hole 334a of the positioning collar 334, thereby securing the operative rod 32 and the positioning collar 334 together. Further, a retainer ring 336 is mounted to a distal end of the stem 332 to prevent the positioning collar 334 from disengaging from the stem 332 and to stop the positioning collar 334 when the positioning collar 334 is moved to a top of the stem 332.

The spring 34 is mounted in the receptacle 327 of the operative rod 32, with an end of the spring 34 abutting against the distal end of the stem 332, and with the other end of the spring 34 abutting against a bottom wall delimiting the receptacle 327, biasing the plug 33 toward the plug seat 314. The elasticity of the spring 34 is so selected that the plug 313 is biased to be in sealing contact with the plug seat 314 and thus seal the hole 313a of the valve body 31 even if the plug 33 is placed upside-down. It is noted that sealing tapes can be provided to the male threading of the coupling hole 315 of the valve body 31 or of the seat 35.

The multifunctional valve device 3 acts as a stop valve when the operative rod 32 is turned in a direction to move the plug 33 to a position (FIG. 6) completely sealing the hole 313a of the valve body 31. The first chamber 316 is not communicated with the second chamber 317, as the hole 313a of the valve body 31 is sealed by the plug 33. Thus, fluid from the inlet 311 cannot flow to the outlet 312. Flowing of the fluid in the multifunctional valve device 3 is stopped. Thus, the multifunctional valve device 3 acts as a stop valve.

When handle 322 is turned in a reverse direction, the operative rod 32 and the plug 33 are moved away from, as shown in FIG. 6A. The fluid from the inlet 311 overcomes the spring force of the spring 34 and urges the plug 33 to disengage from the hole 313a of the valve body 31. Thus, the fluid flows to the outlet 312 via the first chamber 316, the hole 313a of the valve body 31, and the second chamber 317. The flux depends on the distance between the plug 33 and the hole 313a of the valve body 31; namely, the flux depends on rotation of the handle 322. The greater the distance between the plug 33 and the hole 313a of the valve body 31, the greater the flux. Thus, the multifunctional valve device 3 acts as a limiting valve.

Referring to FIG. 6B, when the flow from the inlet 311 toward the outlet 312 stops, no force exerts on the plug 33. The plug 33 is biased to a position sealing the hole 313a of the valve body 31 under the action of the spring 34. In a case that the fluid pressure in the second chamber 317 is greater than that in the first chamber 316 due to heating or other causes, the plug 33 is more tightly engaged with the plug seat 314 in which the hole 313 is defined. This prevents undesired flow in the reverse direction. When the fluid pressure in the second chamber 317 is smaller than that in the first chamber 316, the flow resumes, as the fluid is able to overcome the spring force of the spring 34 and to push the plug 33 away from the hole 313a of the valve body 31, providing normal fluid-delivering function. Thus, the multifunctional valve device 3 acts as a check valve.

Referring to FIG. 6C, when the handle 322 of the operative rod 32 is further turned until the positioning collar 334 is in contact with the retainer ring 336 on the stem 332 of the operative rod 32, the positioning collar 334 presses against the retainer ring 336 and thus causes the plug 33 to move away from the plug seat 314. The check valve function no longer exists. Further, the end of the locking bar 36 is biased by the spring 37 into the positioning groove 326 of the operative rod 32, thereby locking the operative rod 32 in place. Since the positioning collar 334 prevents the retainer ring 336 from moving downward, the fluid may flow from the inlet 311 to the outlet 312 or from the outlet 312 to the inlet 311, allowing fluid flow in both directions. Thus, the multifunctional valve device 3 can be used with a fluid delivering system requiring fluid flow in both directions without the need of additional piping for reverse flow. The installation space for the fluid delivering system can be relatively smaller. The end piece 361 can be pulled outward to move the end of the locking bar 36 out of the positioning groove 326 of the operative rod 32, allowing the handle 332 to be turned in a direction for moving the operative rod 32 toward the plug seat 314, allowing the multifunctional valve device 3 to act as a stop valve, a limiting valve, and a check valve.

As mentioned above, the multifunctional valve device 3 acts as a stop valve when the operative rod 32 is turned to move the plug 33 to a position completely sealing the hole 313a of the valve body 31. The multifunctional valve device 3 acts as a limiting valve and a check valve when the operative rod 32 is turned to move the plug 33 to a position not sealing the hole 313 of the valve body 31. The multifunctional valve device 3 allows flow in both directions when the operative rod 32 is turned to move the plug 33 to a position without the check valve function. This multifunctional valve device 3 can be mounted in any orientation. The number of elements of a piping system using the multifunctional valve 3 can be greatly reduced. Namely, the number of tubes, couplers, and sealing tapes can be reduced while effectively reducing the risk of leakage and cutting the cost.

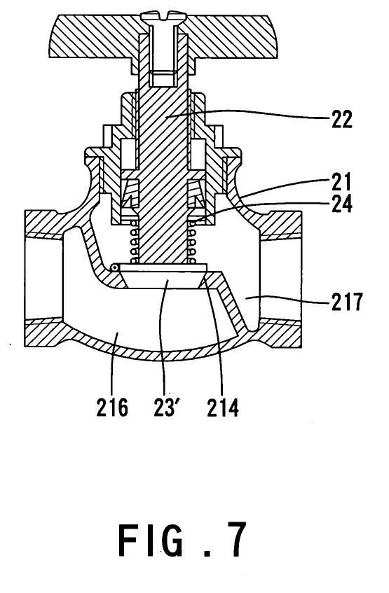

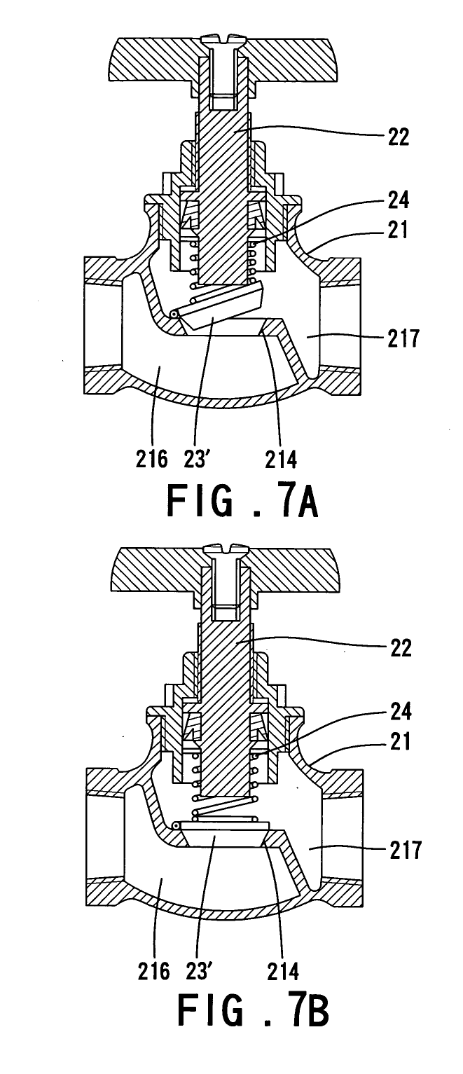

FIG. 7 is a sectional view illustrating an embodiment modified from the first embodiment, wherein the plug (now designated by 23′) has no stem, and the operative rod 22 has no receptacle. An end of the spring 24 directly abuts against the plug 23′, and the other end of the spring 24 abuts against an end face of the operative rod 22. When the operative rod 22 is moved to its lowermost position shown in FIG. 7, the multifunctional valve device acts as a stop valve not allowing flow of fluid in either direction. When the operative rod 22 is moved upward to a position shown in FIG. 7A, the multifunction valve device provides a flow-limiting function in which flow of fluid is allowed when the fluid pressure in the first chamber 216 is greater than that in the second chamber 217. The multifunctional valve device may also act as a check valve when the fluid pressure in the second chamber 217 is greater than that in the first chamber 216, as illustrated in FIG. 7B.

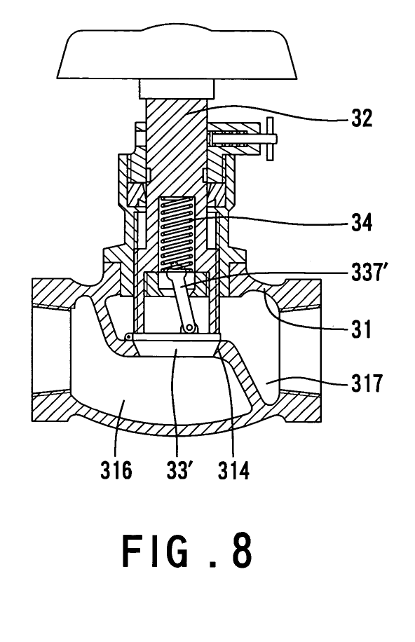

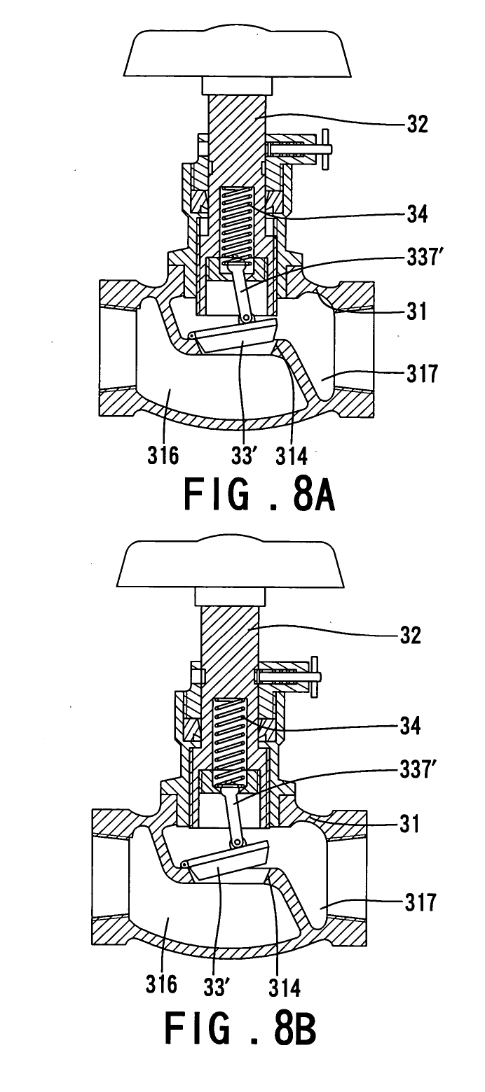

FIG. 8 is a sectional view illustrating an embodiment modified from the second embodiment, wherein the plug (now designated by 33′) has no stem, an end of the spring 34 directly abuts against the plug 33′, and the other end of the spring 34 abuts against a bottom wall delimiting the receptacle of the operative rod 32. When the operative rod 32 is moved upward to a position shown in FIG. 8A, the multifunctional valve device provides a check valve function in which flow of fluid is allowed when the fluid pressure in the first chamber 316 is greater than that in the second chamber 317 and in which flow of fluid is not allowed when the fluid pressure in the second chamber 317 is greater than that in the first chamber 316. When the operative rod 32 is moved to its uppermost position shown in FIG. 8B, the multifunctional valve device allows fluid flow in both directions.

Although the invention has been explained in relation to its preferred embodiment, it is to be understood that many other possible modifications and variations can be made without departing from the scope of the invention as hereinafter claimed.

1. A multifunctional valve device comprising:
a valve body including an inlet, an outlet, a coupling hole, and a partitioning wall separating an interior of the valve body into a first chamber communicated with the inlet and a second chamber communicated with the outlet, the partitioning wall including a hole communicating the first chamber with the second chamber;
a seat coupled in the coupling hole of the valve body and including a screw hole;
a plug mounted in the valve body;
an operative rod threadedly engaged in the screw hole of the seat, the operative rod including a first end abutting against the plug and a second end outside the valve body for manual operation; and
a spring mounted between the operative rod and the plug for biasing the plug toward the hole of the valve body, thereby sealing the hole of the valve body;
wherein when the operative rod is turned to a first predetermined position, the plug is moved to a position sealing the hole of the valve body, preventing flow of fluid in the valve body;
wherein when the operative rod is turned to move the plug away from the hole of the valve body and when there is a fluid flow in the valve body, the fluid flow overcomes the spring force and allows fluid flow; and
wherein when the operative rod is turned to move the plug away from the hole of the valve body, the plug is moved to seal the hole of the valve body under at least one of the spring force and a pressure difference between a pressure in the first chamber and a pressure in the second chamber.

2. The multifunctional valve device as claimed in claim 1, with the first end of the operative rod including a receptacle, with the plug including a stem slidably received in the receptacle.

3. The multifunctional valve device as claimed in claim 1, with a handle coupled to the second end of the operative rod for manual operation.

4. The multifunctional valve device as claimed in claim 1, further including means for retaining the operative rod in a position where the plug is disengaged from the hole of the valve body, allowing fluid flow in both directions.

5. The multifunctional valve device as claimed in claim 4, with the first end of the operative rod including a receptacle, with the plug including a stem slidably received in the receptacle, with a positioning collar being mounted around the stem of the plug and securely engaged with the operative rod, with a retainer ring being mounted to the stem for stopping the positioning collar when the positioning collar is moved to a position in contact with the retainer ring.

6. The multifunctional valve device as claimed in claim 5, with an end of the spring abutting against a bottom wall delimiting the receptacle of the operative rod, and with another end of the spring abutting against the stem.

7. The multifunctional valve device as claimed in claim 5, with the operative rod including a positioning groove in an outer periphery thereof, with a sealing member being mounted in the coupling hole of the valve body, with the sealing member including a longitudinal hole through which the operative rod extends, with an extension extending from a side of the sealing member and including a transverse hole communicated with the longitudinal hole of the sealing member, with a locking bar being received in the transverse hole, with another spring being mounted in the transverse hole for biasing an end of the locking bar toward the operative rod, wherein when the operative rod is moved to a position where the positioning collar is in contact with the retainer ring, the end of the locking bar is biased by said another spring into the positioning groove of the operative rod, thereby retaining the operative rod and the plug in place.

8. The multifunctional valve device as claimed in claim 7, with an end piece being attached to another end of the locking bar located outside the extension, wherein when the end piece is pulled away from the extension, the unlocking bar is disengaged from the positioning groove of the operative rod, allowing the operative rod to be turned for moving the plug relative to the hole of the valve body.
